(19) United States
(12) Patent Application Publication
(10) Pub. No.: US 2004/0122534 A1
(43) Pub. Date: Jun. 24, 2004

(54) Method for facilitating computer-based modeling

(76) Inventor: Matthew A. Paulin, Seattle, WA (US)

Correspondence Address: HOVEY WILLIAMS LLP, 2405 GRAND BLVD., SUITE 400, KANSAS CITY, MO, 64108, US

(21) Appl. No.: 10/651,731

(22) Filed: Aug. 29, 2003

Related U.S. Application Data
(60) Provisional application No. 60/407,512, filed on Aug. 30, 2002.

(51) Int. Cl. G05B 11/01; G05B 13/02

(52) U.S. Cl. 700/30; 700/31; 700/19

(57) ABSTRACT

A method for facilitating computer-based modeling using a limited set of fundamental elements that can be defined and customized and connected, combined, or otherwise associated using a limited set of fundamental behaviors so as to populate the model to create or facilitate, for example, simulations of actual physical processes, problem solutions, virtual reality worlds, and artificial intelligence experiments. Each type of fundamental element may be provided with a virtual physical characteristic (e.g., color, shape) to allow for visually debugging the model by viewing the fundamental elements and their interactions.

### RELATED APPLICATIONS

The present non-provisional patent claims priority benefit, with regard to all common subject matter, of a copending U.S. provisional patent application titled METHOD FOR FACILITATING COMPUTER-BASED MODELING, Serial No. 60/407,512, filed Aug. 30, 2002. The identified provisional application is hereby incorporated by reference into the present non-provisional application.

### BACKGROUND OF THE INVENTION

1. Field of the Invention

The present invention is broadly related to methods, techniques, mechanisms, and other tools for facilitating computer-based modeling. More particularly, the present invention concerns a method for facilitating computer-based modeling using a limited set of fundamental elements that can be defined and customized and connected, combined, or otherwise associated using a limited set of fundamental behaviors so as to populate the model to create or facilitate, for example, simulations of actual physical processes, problem solutions, virtual reality worlds, and artificial intelligence experiments.

2. Description of the Prior Art

It will be appreciated that it is often desirable or necessary to model or simulate a physical process or problem solution. It is well-known, for example, to create a virtual model of an engineered system, whether mechanical, electrical, or otherwise in nature, to test the system under various simulated conditions prior to committing to the construction and use of the actual physical system.

Unfortunately, prior art models are typically custom-created, and therefore can require undesirably long development and testing times and can be exceedingly expensive. Furthermore, prior art modeling methods often involve the creation of one or more virtual constructs that are highly complex. These constructs are typically created at a very high level, with no more fundamental or basic element to the model, which makes creation, debugging, and modifying the constructs undesirably time-consuming and otherwise inefficient. Additionally, the various complex constructs that populate the model are typically created with a high degree of dependence, both with regard to the nature of the model and to the other constructs populating it, and are therefore not useable to create other models of differing natures. Thus, for example, a computer-based model created to test various aspects of performance of a proposed, virtual aircraft, is not useable, nor is its method of creation or its code adaptable for use, in the creation of a computer-based model for simulating a chemical reaction, even though, at a fundamental level, both systems involve matter and energy subject to a finite set of physical laws.

Furthermore, debugging prior art models typically requires searching through, reading, and analyzing hundreds, thousands, or even millions of lines of source code to identify and fix a logical error.

Due to the above-identified and other problems and disadvantages in the art, a need exists for an improved mechanism for facilitating computer-based modeling and simulation.

### SUMMARY OF THE INVENTION

The present invention overcomes the above-described and other problems and disadvantages by providing a method for facilitating the creation of computer-based or virtual models using a limited set of fundamental elements that can be defined and customized and connected, combined, or otherwise associated using a limited set of fundamental behaviors so as to populate the model to create or facilitate, for example, simulations of actual physical processes, problem solutions, virtual reality worlds, and artificial intelligence experiments.

The present method is distinguished from well-known object-oriented programming in that, whereas spatial programming is concerned with employing the aforementioned fundamental elements, object-oriented programming is concerned generally with designing various components of a system to be reusable. Thus, in certain applications it may or may not be an exercise in object-oriented programming to create the fundamental elements of the present invention, but it always involves the method of the present invention to employ them in the manner set forth herein.

Practicing the method involves creating or selecting and, as necessary, modifying a finite set of types of the fundamental elements and, for each such type, defining a finite set of behaviors. Thereafter, the model is populated with a plurality of the fundamental elements of the finite set of types. The fundamental elements are independent of one another and reusable to create other models. The defined behaviors facilitate predictable relationships and interactions, thereby further facilitating the modeling of actual physical processes.

Thus, it will be appreciated that the present invention provides a number of substantial advantages over the prior art, including, for example, providing fundamental elements with known or determinable behaviors to all possible occurrences, thereby facilitating the creation of a virtual model having behaviors that mimic reality and actual physical processes. Furthermore, because the fundamental elements, once created, are fundamental in nature and display predictable behaviors, they are reusable and can be used in numerous models with little or no adaptation. Additionally, a virtual physical appearance, such as a particular shape or color, can be associated with each type of fundamental element, thereby advantageously allowing for visual inspection and debugging of the model rather than, as is required in the prior art, attempting to identify logical errors in hundreds, thousands, or even millions of lines of textual source code.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a depiction of fundamental elements created and used in practicing the preferred embodiment of the method of the present invention; and

FIG. 2 is a depiction of a model created by and a viewer and a controller used in practicing the method.

### DETAILED DESCRIPTION OF A PREFERRED EMBODIMENT

With reference to the figures, a method of spatial programming is herein described, shown, and otherwise disclosed in accordance with a preferred embodiment of the present invention. Broadly, the method facilitates the creation of computer-based or virtual models using a limited set of fundamental elements, hereinafter referred to as “Entities”, that can be defined and customized and connected, combined, or otherwise associated using a limited set of fundamental behaviors, hereinafter referred to as “Actions”, so as to populate the model to create or facilitate, for example, simulations of actual physical processes, problem solutions, virtual reality worlds, and artificial intelligence experiments.

The present method of spatial programming is distinguished from well-known object-oriented programming in that, whereas spatial programming is concerned with employing, as mentioned, a limited set of the Entities and their possible Actions, object-oriented programming is concerned with designing various components of a system to be reusable. Thus, in certain applications it may or may not be an exercise in object-oriented programming to create the Entities of the present invention, but it is always an exercise in spatial programming to employ the Entities in the manner set forth herein.

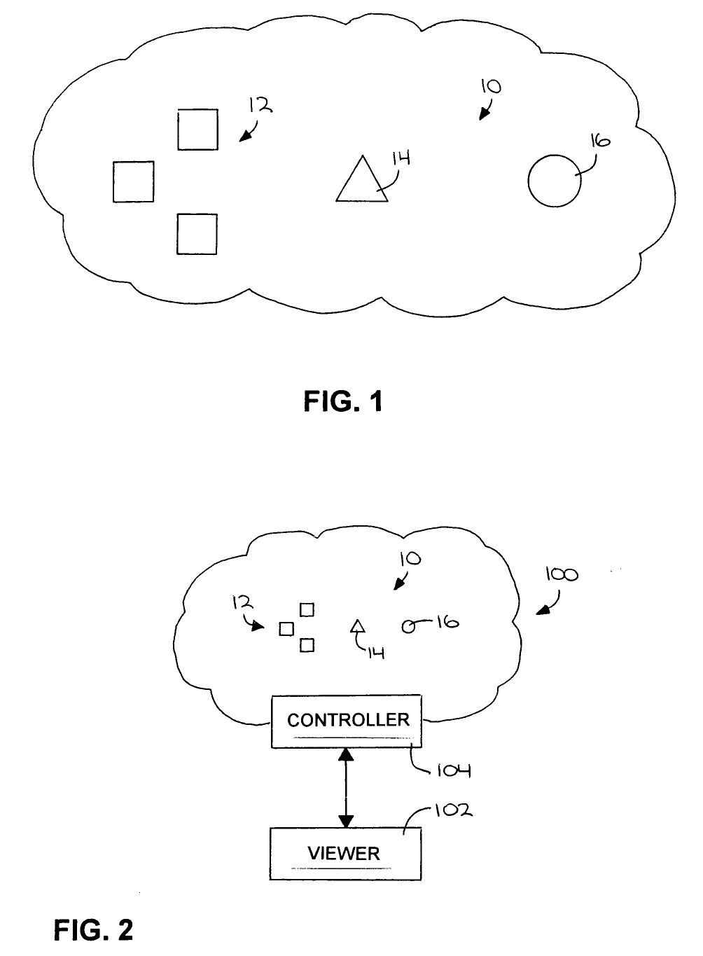

As mentioned, referring particularly to FIG. 1, Entities 10 are the most fundamental elements or units available to the Spatial Programmer; they are the basic building blocks of which virtual worlds may be created. The Entities 10 are generic elements that can be defined or otherwise customized and connected, combined or otherwise associated to populate the model in any manner desired.

The Spatial Programmer is restricted to a limited set of types of Entities 10 that are sufficient, alone or in combination, due to their fundamental nature, to model the system in question. Possible types of Entities 10 include, for example:

| | |
|---|---|
| Simple Entity 12 | The simplest form of an Entity, able only to react |
| | to Actions performed on it. |
| Alert Entity 14 | An Entity which is notified of or capable of |
| | detecting the status of another Entity, such as, |
| | for example, the proximity of the other Entity to |
| | the Alert Entity. |
| Action Entity 16 | An Entity able to perform an Action, either of its |
| | own accord or under another's control, such as, |
| | for example, a user or software robot (SoftBot). |

Each Entity or Entity-type may be provided a virtual physical characteristic, marker, or identifier, such as a distinguishing color or shape, sufficient to identify that Entity or Entity-type and assist in debugging through observation of the working model. As shown in FIG. 1, for example, the aforementioned Entity-types are provided with different shapes that are easily and quickly identifiable during debugging.

Actions involve behaviors of and relationships between Entities. The Spatial Programmer is limited to a finite set of Actions which are sufficient, alone or in combination, due to their fundamental nature, to model the system in question. An Entity involved in an Action may be characterized as having one of the following roles:

| | |
|---|---|
| Enactor | An Entity that is the source or initiator of an |
| | Action. |
| Reactor | An Entity that is a target of or is otherwise |
| | affected by an Action. |
| Observer | An Entity that is informed or can detect that an |
| | Action has occurred. |
| Interceptor | An Entity that affects an effect of an Action, such |
| | as, for example, preventing the Action from |
| | reaching or affecting a Reactor. |
| Diactor | An Entity that begins or initiates an Action on |
| | behalf of another Entity. |

An Action occurs to change some relationship between Entities in the model. The beginning or initiation of an Action is referred to as an “enaction”; the change resulting from the Action is referred to as the “reaction”. An Action initiated by one Entity on behalf of another Entity is referred to as a “diaction”. The Reactor to a diaction may perceive the diaction to have been initiated by the Diactor or by the Entity on whose behalf the Action was initiated, depending on the nature of the Action and the Entities involved.

Action observed by an Entity is referred to as an “observation”. An Alert Entity might, for example, perform observations in order to detect an Action between two or more other Entities. It will be appreciated that, in some situations, Enactors and Reactors are not necessarily aware of one another and are, therefore, not necessarily Observers. In other situations, however, the Alert Entity may be a Reactor set to observe Actions initiated against it. In this latter situation, the Alert Entity might be used, for example, as a sensor positioned to be within the influence of and affected by an Action of interest.

Action blocked or intercepted by an Entity is referred to as an “interception”. An Interceptor Entity might be used, for example, in conjunction with an Alert Entity, wherein the Alert Entity observes an Action initiated by a first Entity against a second Entity and communicates such observation to the Interceptor who then intercepts the Action prior to its affecting the second Entity. Interceptors could be set, for example, to intercept certain types of Actions initiated by an Enactor (e.g., preventing an emission of radiation at or near its source), or to intercept certain types of Actions sent against a Reactor (e.g., preventing an absorption of radiation at or near its target). Thus, in this light, an Interceptor could be used to create a box, wall, fence, or other enclosure about one or more other Entities.

A Connector, for example, is a particular type of Interceptor operable to connect two other Entities together by intercepting all movement-related Actions directed toward them. Alternatively, the Entity might intercept a movement-related Action directed toward one of the Entities and then diact identical Actions against both Entities so that movement of both occurs without relative movement of either.

Thus, every Action may begin with an Enactor or Diactor, and thereafter affects a Reactor, is observed by an Observer, or is intercepted by an Interceptor. Note that Entities' roles may change quickly and often during an exchange, such as, for example, where a Reactor, in response to an Action, becomes, in turn, an Enactor.

An Entity is only aware of other Entities through its interactions with those other Entities. Each type of Entity will react to an Action using only a known and limited set of Actions, or behaviors, or its own. This predictability of reaction or response facilitates the creation of virtual systems that model reality. Because each type of Entity must be provided with a reactive behavior for each type of Action, the set of Action-types is preferably kept small. Thus, just as Entities are fundamental elements of spatial programming, Actions are fundamental behaviors or relationships which, alone or in combination, are sufficient to model or simulate substantially any system.

An Entity API facilitates creation of new Entities or modification of existing Entities by an Entity Programmer. Because Entities are fundamental in nature, each having no dependence on others for its existence, they can be reused, mixed, and matched to create any number of virtual worlds. As mentioned, however, for each type of Entity created, there must be defined the types of behaviors (i.e., Actions) associated with that Entity, including, for example, its responsive behaviors as a Reactor.

The Spatial Programmer performs the act of spatial programming as described herein, broadly involving the selection and use of Entities and Actions required to model a physical process. In one embodiment, referring to FIG. 2, spatial programming involves the creation of the model 100, interfacing the model 100 with a viewer 102 using a controller 104, and interacting with the model 100 via the viewer 102.

The model 100 is constructed of one or more Entities 10 of one or more types whose definitions determine the capabilities and limits of the model. Everything in the model is either an Entity or constructed from a plurality of associated Entities. A World is the set of all Entities used to create the model and the set of all Actions defining the behaviors, relationships, and interactions of those Entities.

The viewer is operable to provide a user interface for communicating with the model. The viewer uses a viewer API to provide such communication, including user interaction with the model. The viewer API may take any form, including, for example, pure text, two-dimensional graphics, or three-dimensional graphics with sound, as may appropriate given the nature of the model. The viewer can also be used to debug the model during its construction based on the virtual physical characteristic ascribed to each Entity or type of Entities.

The controller is operable to interface the model with the viewer and to allow for user interaction with the model. Typically, users use the controller to control and otherwise interact with Controlled Entities. Users log into the Controlled Entities to issue commands or receive information about the model.

Creation of a computer program implementing the Entities, viewer, controller, and various other concepts disclosed herein as being part of the method of the present invention is considered to be within the ability of one with ordinary skill in the art of computer programming. Exemplary portions of one possible implementing computer program are included in the above-identified provisional patent application which has been incorporated by reference into the present disclosure.

In exemplary use and operation, the method of the present invention proceeds as follows. A Spatial Programmer, given the task of creating a model of a certain physical process, accesses a library of existing Entity types and selects those Entities which will be used in the model. As needed, the Spatial Programmer uses the Entity API to create a needed Entity-type not available from the library or to modify an available Entity-type. As required, the Entity API is also used to add, delete, or modify each Entity-type's behavior, such that, thereafter, all Entities of that type will predictably share the same behaviors. The Spatial Programmer then populates the model with Entities of the various desired types.

The model may then be viewed using the viewer. If the Entities are provided with distinctive visual characteristics, such as, for example, specific colors or shapes, debugging may be at least partially accomplished through observation of the model via the viewer.

As necessary or desired, such as when triggering or initiating the modeled physical process, the Spatial Programmer or another user uses the controller to interact with the model, as, for example, via a Controlled Entity.

From the preceding description, it will be appreciated that the method of the present invention provides a number of substantial advantages over prior art computer-based modeling or simulation methods, including for example, providing fundamental elements with known or determinable behaviors to all possible occurrences, thereby facilitating the creation of a virtual model having predictable overall behaviors that mimic reality and actual physical processes. Furthermore, because the fundamental elements, once created, are fundamental in nature and display predictable behaviors, they are reusable and can be used in numerous models with little or no adaptation. Additionally, a virtual physical appearance, such as a particular shape or color, can be associated with each type of fundamental element, thereby advantageously allowing for visual inspection and debugging of the model rather than, as is required in the prior art, attempting to identify logical errors in hundreds, thousands, or even millions of lines of textual source code.

Although the invention has been described with reference to the preferred embodiments illustrated in the attached drawings, it is noted that equivalents may be employed and substitutions made herein without departing from the scope of the invention as recited in the claims. For example, as mentioned, any type of Entity may be created having any appropriate or desired behavior, but it is preferred that the set of all Entity types be kept to a minimum so as to preserve the Entity's substantially fundamental nature which provides the aforementioned advantages.

Having thus described the preferred embodiment of the invention, what is claimed as new and desired to be protected by Letters Patent includes the following:

1. A method of modeling a physical process using a computer, the method comprising the steps of:
(a) selecting a set of types of fundamental elements, wherein the set of types of fundamental elements is limited to a minimum number of types of fundamental elements necessary to model the physical process;
(b) defining for each type of fundamental elements a set of behaviors;
(c) populating a model with a plurality of fundamental elements selected from the set of types of fundamental elements;
(d) viewing the plurality of fundamental elements within the model using a viewing mechanism adapted to present the plurality of fundamental elements in a visually perceptible manner; and
(e) controlling one or more of the plurality of fundamental elements via an interface with the model.

2. The method as set forth in claim 1, further including the steps of associating each type of fundamental element with a virtual physical characteristic, wherein the virtual physical characteristic of each type of fundamental element is made visually perceptible by the viewing mechanism.

3. The method as set forth in claim 2, wherein the virtual physical characteristic involves color.

4. The method as set forth in claim 2, wherein the virtual physical characteristic involves shape.

5. A method of modeling a physical process using a computer, the method comprising the steps of:
(a) selecting a set of types of fundamental elements;
(b) defining for each type of fundamental element a set of behaviors;
(c) associating each type of fundamental element with a virtual physical characteristic;
(d) populating a model with a plurality of fundamental elements selected from the set of types of fundamental elements;
(e) viewing the plurality of fundamental elements of the model using a viewing mechanism adapted to present the plurality of fundamental elements in a visually perceptible manner, wherein the virtual physical characteristic of each element is made visually perceptible by the viewing mechanism; and
(f) controlling one or more of the plurality of fundamental elements via an interface with the model.

6. The method as set forth in claim 5, wherein the virtual physical characteristic involves color.

7. The method as set forth in claim 5, wherein the virtual physical characteristic involves shape.

8. A method of modeling a physical process using a computer, the method comprising the steps of:
(a) providing a library of types of fundamental elements, wherein a set of behaviors is defined for each type of fundamental element, and wherein a virtual physical characteristic is associated with each type of fundamental element;
(b) allowing for populating a model with a plurality of fundamental elements selected from the library of types of fundamental elements;
(c) providing a viewing mechanism for viewing the plurality of fundamental elements within the model in a visually perceptible manner, wherein the virtual physical characteristic of each element is made visually perceptible by the viewing mechanism; and
(d) providing an interface for controlling one or more of the plurality of fundamental elements in the model.

9. The method as set forth in claim 8, wherein the virtual physical characteristic involves color.

10. The method as set forth in claim 8, wherein the virtual physical characteristic involves shape.
